(19) United States
(12) Patent Application Publication
(10) Pub. No.: US 2020/0318226 A1
(43) Pub. Date: Oct. 8, 2020

(54) ALUMINUM ALLOY WIRE

(71) Applicant: SWCC SHOWA CABLE SYSTEMS CO., LTD., Tokyo (JP)

(72) Inventors: Teruhito NAKATSU, Kanagawa (JP); Masahiro ICHIKAWA, Kanagawa (JP); Akira IMAI, Kanagawa (JP); Hiroyoshi YAMAZAKI, Miyagi (JP); Susumu OHNEDA, Kanagawa (JP); Akira TAKEHIRA, Kanagawa (JP)

(21) Appl. No.: 16/909,646

(22) Filed: Jun. 23, 2020

Related U.S. Application Data
(62) Division of application No. 15/738,702, filed on Dec. 21, 2017.

(30) Foreign Application Priority Data
Jun. 30, 2015 (JP) 2015-131922

(51) Int. Cl. C22F 1/05; C22F 1/04; C22F 1/02; C22C 21/08; C22C 21/02; B21C 1/02; C22C 21/04; H01B 1/02; H01B 13/00

(52) U.S. Cl. CPC C22F 1/05; C22F 1/04; C22F 1/02; C22C 21/08; C22C 21/02; C22F 1/00; C22C 21/04; H01B 1/023; H01B 13/0016; H01B 13/0036; B21C 1/02

(57) ABSTRACT

An aluminum alloy wire manufacturing method comprises (A) a step for melting an aluminum alloy containing 0.40-0.55 mass % of Mg and 0.45-0.65 mass % of Si, the balance being obtained from Al and unavoidable impurities, (B) a step for casting molten metal of the aluminum alloy and rolling to form a rough-drawn wire rod, (C) a step for solutionizing the rough-drawn wire rod, (D) a step for drawing the rough-drawn wire rod after solutionizing to form a drawn wire rod with a wire diameter of 0.5 mm or less, and (E) a step for heat treatment so that internal strain is removed with substantially no deposition of Mg₂Si.

### CROSS REFERENCE TO RELATED APPLICATIONS

The present application is a Divisional Application of application Ser. No. 15/738,702, filed Dec. 21, 2017, which is a 371 of International Application No.: PCT/JP2016/002663, filed Jun. 2, 2016, which claims priority from Japanese Patent Application No. 2015-131922 filed on Jun. 30, 2015, the contents of which are incorporated herein by reference.

### TECHNICAL FIELD

The present invention relates to a method for producing an aluminum alloy wire and an aluminum alloy wire, and particularly relates to a method for producing an aluminum alloy wire and an aluminum alloy wire that are suitable in a wire harness application.

### BACKGROUND ART

In recent years, aluminum electric wires have been used instead of copper electric wires in the field of a wire harness for use in car interior wirings and the like of automobiles in terms of a reduction in weight. In-car wire harnesses are continuously subjected to vibration and impact in driving, and thus are demanded to be resistant thereto. An aluminum electric wire having excellent mechanical properties (strength and malleability (elongation)) can be applied to result in an enhancement in impact resistance. An Al—Mg—Si-based alloy (6000 series aluminum alloy) has been conventionally applied as an aluminum electric wire for wire harnesses (for example, PTLS 1 to 12). The Al—Mg—Si-based alloy is a precipitation-strengthened aluminum alloy whose mechanical strength is increased by performing an aging treatment at the final stage of a production process to thereby precipitate Mg₂Si in an aluminum alloy. The aging treatment is performed by, for example, retaining at a high temperature of 150° C. or more for 1 hour or more.

### CITATION LIST

### Patent Literature

### PTL 1

### Japanese Unexamined Patent Application Publication (Translation of PCT Application) No. 2013-542320

### PTL 2

### Japanese Patent Application Laid-Open No. 2015-96645

### PTL 3

### Japanese Patent No. 5607853

### PTL 4

### Japanese Patent No. 5607854

### PTL 5

### Japanese Patent No. 5607855

### PTL 6

### Japanese Patent No. 5607856

### PTL 7

### Japanese Patent Application Laid-Open No. 2012-229485

### PTL 8

### Japanese Patent Application Laid-Open No. 2013-76168

### PTL 9

### Japanese Patent Application Laid-Open No. 2012-46824

### PTL 10

### Japanese Patent Application Laid-Open No. 2012-214901

### PTL 11

### Japanese Patent Application Laid-Open No. 2011-195962

### PTL 12

### Japanese Patent Application Laid-Open No. 2008-112620

### SUMMARY OF INVENTION

### Technical Problem

While an extra fine wire having a wire diameter of 0.5 mm or less is believed to be suitable in a wire harness application, such an extra fine wire is progressively processed and hardened, and thus hardly achieves good malleability. Furthermore, while a precipitate in an Al—Mg—Si alloy is effective for an enhancement in strength, the precipitate causes deterioration in malleability. In addition, the precipitate can also cause the occurrence of disconnection (the origin of disconnection).

An object of the present invention is to provide a method for producing an aluminum alloy wire, which can easily produce an aluminum alloy wire having characteristics suitable in a wire harness application and which can also enhance productivity, as well as an aluminum alloy wire having characteristics suitable in a wire harness application.

### Solution to Problem

A method for producing an aluminum alloy wire, according to the present invention includes: melting an aluminum alloy comprising 0.40 to 0.55 mass % of Mg, 0.45 to 0.65 mass % of Si, and the balance including Al and unavoidable impurities; casting and rolling a molten metal of the aluminum alloy, to form a rough-drawn wire rod; subjecting the rough-drawn wire rod to a solution treatment; drawing the rough-drawn wire rod subjected to the solution treatment, to form a drawn wire rod having a wire diameter of 0.5 mm or less; and performing a heat treatment so that internal strain is removed without substantial precipitation of Mg₂Si.

An aluminum alloy wire according to the present invention is an aluminum alloy wire formed by drawing an aluminum alloy comprising 0.40 to 0.55 mass % of Mg, 0.45 to 0.65 mass % of Si, and the balance including Al and unavoidable impurities, in which a Mg₂Si precipitate is not substantially present in an alloy.

### Advantageous Effects of Invention

According to the present invention, an aluminum alloy wire having characteristics suitable in a wire harness application can be easily produced and also productivity is remarkably enhanced.

### BRIEF DESCRIPTION OF DRAWINGS

FIG. 1 illustrates a flow chart of a production process of an aluminum alloy wire according to an embodiment;

FIG. 2 illustrates a table representing the production conditions and the evaluation results of Examples 1 to 6;

FIG. 3 illustrates a table representing the production conditions and the evaluation results of Examples 7 to 12; and

FIG. 4 illustrates a table representing the production conditions and the evaluation results of Comparative Examples.

### DETAILED DESCRIPTION

Hereinafter, embodiments of the present invention will be described in detail with reference to the accompanying drawings.

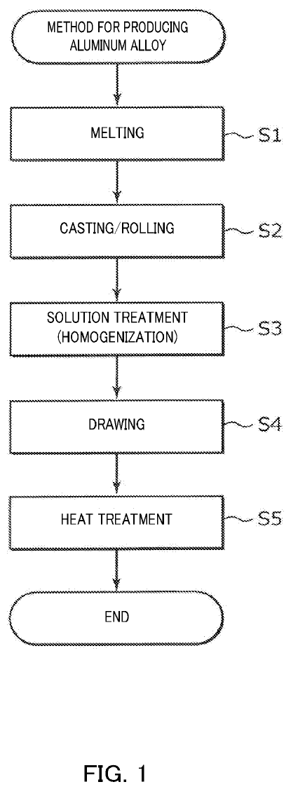

FIG. 1 is a flow chart illustrating a production process of an aluminum alloy wire according to one embodiment of the present invention. As illustrated in FIG. 1, a method for producing an aluminum alloy wire according to the present embodiment includes steps S1 to S5.

Step S1 is to melt an aluminum alloy. The aluminum alloy to be molten contains 0.40 to 0.55 mass % of Mg and 0.45 to 0.65 mass % of Si, the balance including Al and unavoidable impurities. The unavoidable impurities include 0.32 mass % or less of Fe, 0.01 mass % or less of Cu, 0.01% or less of Mn, 0.01 mass % or less of Ti, and 0.003 mass % or less of V.

Step S2 is to cast and roll a molten metal of the aluminum alloy molten in step S1, to form a rough-drawn wire rod. Step S2 is performed according to, for example, a properzi system (continuous cast-rolling system). The wire diameter of the rough-drawn wire rod is, for example, ϕ8.0 to 10.0 mm.

Step S3 is to subject the rough-drawn wire rod formed in step S2 to a solution treatment. The solution treatment is a treatment where alloy components (Mg, Si, and the like) not molten, of the aluminum alloy, are subjected to solid solution formation (so-called solid solution formation). The solution treatment allows a compound (representatively Mg₂Si) formed in step S2 to be dispersed, thereby making the internal texture of the rough-drawn wire rod uniform (homogenization treatment). The solution treatment is performed by, for example, retaining at 500 to 600° C. for 0.5 to 10 hours and thereafter quenching.

While the solution treatment in step S3 can also be performed after drawing in step S4, the solution treatment is preferably performed before drawing as in the present embodiment. If a fine wire subjected to drawing is subjected to the solution treatment, the fine wire is subjected to a heat treatment at a high temperature in a bobbin-wound form or a bound form, thereby causing wire adhesion, to result in the risk of disconnection in peeling of such a wire. In addition, if such a heat treatment at a high temperature is continuously performed, the setting of tension is extremely difficult, and the change in wire diameter and the occurrence of disconnection are caused even by a small change in tension. On the contrary, a heat treatment at a high temperature of a wire having a large diameter, not subjected to drawing, has a low risk of such disadvantages, and the heat treatment has an advantage of being capable of homogenization at the initial stage of a process even if any ununiformity is caused during casting and rolling.

Step S4 is to draw the rough-drawn wire rod subjected to the solution treatment, to form a drawn wire rod. Step S4 is performed by, for example, extraction with a taper-shaped die. The wire diameter of a drawn wire rod to be finally formed is, for example, 0.2 to 0.5 mm.

Step S4 preferably includes subjecting a drawn wire rod (intermediate drawn wire rod) being subjected to drawing, to a heat treatment (intermediate heat treatment). The intermediate heat treatment can be appropriately performed to thereby remove strain introduced into the intermediate drawn wire rod, resulting in an enhancement in subsequent drawing processability. In addition, an enhancement in elongation of an aluminum alloy wire to be finally obtained is also achieved. The intermediate heat treatment temperature is, for example, 100 to 140° C. The intermediate heat treatment time is longer as the heat treatment temperature is lower.

Step S5 is to remove the internal strain of the drawn wire rod processed and hardened in the drawing, by a heat treatment, to soften the drawn wire rod to result in an enhancement in malleability (so-called annealing). The heat treatment temperature and the heat treatment time in step S5 are set so that the effect due to the annealing is obtained and also Mg₂Si is not substantially precipitated. In other words, step S5 is clearly different from an aging treatment conventionally performed, in that step S5 is performed so as not to precipitate Mg₂Si.

The phrase “Mg₂Si is not substantially precipitated” encompasses not only a case where Mg₂Si is not precipitated at all, but also a case where Mg₂Si is slightly precipitated.

Specifically, the heat treatment temperature in step S5 is preferably 100 to 140° C., more preferably 120 to 140° C. The reason for this is because a heat treatment temperature of less than 100° C. causes the annealing to take a longer time and a heat treatment temperature of more than 140° C. causes a Mg₂Si compound to be easily precipitated. The heat treatment time is determined according to a relationship with the heat treatment temperature as long as the effect due to the annealing is obtained (the heat treatment time is longer as the heat treatment temperature is lower). When the heat treatment time is 100 to 140° C., the heat treatment time is set to 3 to 20 hours. When the heat treatment temperature and the heat treatment time are set so, Mg₂Si is confirmed not to be precipitated.

The method for producing an aluminum alloy wire according to the present embodiment thus includes (A) (step S1) melting an aluminum alloy containing 0.40 to 0.55 mass % of Mg and 0.45 to 0.65 mass % of Si, the balance including Al and unavoidable impurities, (B) (step S2) casting and rolling a molten metal of the aluminum alloy, to form a rough-drawn wire rod, (C) (step S3) subjecting the rough-drawn wire rod to a solution treatment, (D) (step S4) drawing the rough-drawn wire rod subjected to the solution treatment, to form a drawn wire rod having a wire diameter of 0.5 mm or less, and (E) (step S5) performing a heat treatment so that internal strain is removed with Mg₂Si being not substantially precipitated.

The aluminum alloy wire produced according to steps S1 to S5 described above not only has strength and conductivity that are comparable with those of an aluminum alloy wire to be produced according to a conventional method including an aging treatment, but also allows the elongation in terms of malleability to be enhanced to 7% or more. In addition, Mg₂Si that can lead to the origin of disconnection is not substantially precipitated in the alloy, and thus an enhancement in reliability is also achieved. Furthermore, an aging treatment that has been considered to be essential for an enhancement in strength is not required. Accordingly, an aluminum alloy wire having characteristics suitable in a wire harness application can be easily produced and also productivity is remarkably enhanced.

### Examples

Each aluminum alloy wire in Examples 1 to 12 was produced according to steps S1 to S5. Specifically, in step S1, an aluminum alloy containing 0.5 mass % of Mg and 0.6 mass % of Si, the balance including Al and unavoidable impurities, was molten. In step S2, a rough-drawn wire rod having a wire diameter of 9.5 mm was formed according to a properzi system. In step S3, there was performed a solution treatment including retaining at 550° C. for 5.5 hours and thereafter quenching to room temperature.

Next, extraction with a die was made to thereby form a drawn wire rod having a wire diameter of 0.32 mm in step S4. In Examples 1 to 9, an intermediate drawn wire rod was subjected to an intermediate heat treatment, during drawing until the wire diameter reached 0.32 mm. The intermediate heat treatment temperature was set to 140° C. (Examples 1 to 3), 130° C. (Examples 4 to 6), or 120° C. (Examples 7 to 9), and all the intermediate heat treatment times were set to 10 hours.

Finally, in step S5, the drawn wire rod was subjected to a final heat treatment. The final heat treatment temperature was set to 140° C. (Examples 1, 4, 7, 10), 130° C. (Examples 2, 5, 8, 11), or 120° C. (Examples 3, 6, 9, 12). The final heat treatment time in each Example was varied within the range from 3 to 10 hours.

### Comparative Examples

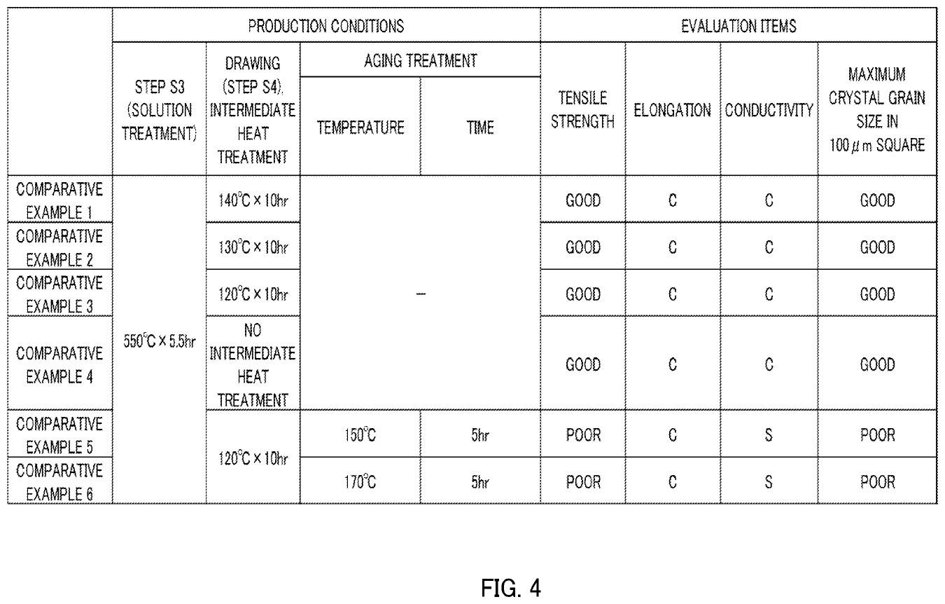

In Comparative Examples 1 to 4, the same manner as in Examples 1 to 12 was performed with respect to steps S1 to S4 (see FIG. 4 for details), and no step S5 was performed. In Comparative Examples 5 and 6, the same manner as in Examples 1 to 3 was performed with respect to steps S1 to S4, and an aging treatment (150° C.×5 hours or 170° C.×5 hours) was performed instead of the final heat treatment in step S5, to precipitate Mg₂Si.

[Evaluation Results]

The aluminum alloy wire obtained in each of Examples 1 to 12 and Comparative Examples 1 to 6 was subjected to measurements of the tensile strength, the elongation ad the conductivity, and evaluated with respect to characteristics in a wire harness application. In addition, an area of 100-μm square of the cross-sectional section of the aluminum alloy wire was observed by an electron microscope.

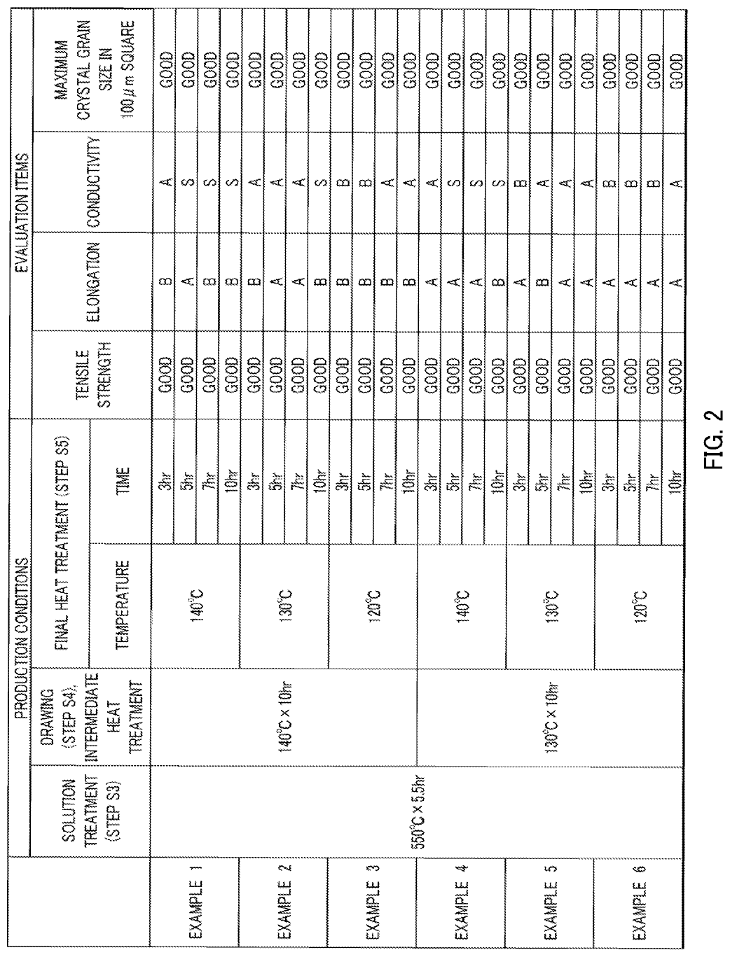

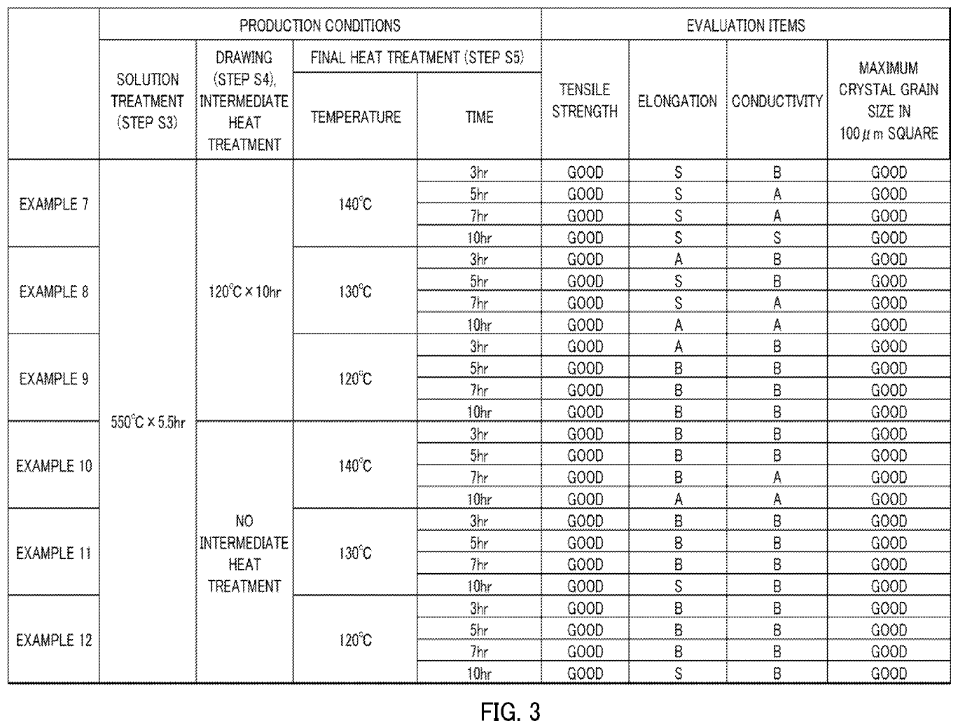

The production conditions and the evaluation results of the aluminum alloy wire are illustrated in FIG. 2 to FIG. 4. In FIGS. 2 to 4, a tensile strength of 350 MPa or more is rated as “GOOD”, and a tensile strength of less than 350 MPa is rated as “POOR”. An elongation of 8% or more is rated as “S”, an elongation of 7% or more and less than 8% is rated as “A”, an elongation of 6% or more and less than 7% is rated as “B”, and an elongation of less than 6% is rated as “C”. A conductivity of 53% IACS or more is rated as “S”, a conductivity of 52% IACS or more and less than 53% IACS is rated as “A”, a conductivity of 50% IACS or more and less than 52% IACS is rated as “B”, and a conductivity of less than 50% IACS is rated as “C”. With respect to the cross section observation, a maximum crystal grain size of 10 μm or less is rated as “GOOD” and a maximum crystal grain size of more than 10 μm is rated as “POOR”. An aluminum alloy wire for wire harnesses is demanded to have a tensile strength of 350 MPa or more (Rating “GOOD”), an elongation of 6% or more (Rating B or higher) and a conductivity of 50% IACS or more (Rating B or higher) for practical reasons.

As illustrated in FIG. 2 to FIG. 4, it was confirmed from comparison of Examples 1 to 12 with Comparative Examples 1 to 6 that the final heat treatment in step S5 was performed to result in an enhancement in elongation. In addition, it was confirmed from comparison of Examples 1 to 12 with Comparative Examples 5 and 6 that comparable tensile strength and conductivity were ensured and the elongation was enhanced to 8% or more even in an aluminum alloy wire that was not subjected to any aging treatment, namely, that had no Mg₂Si precipitated. In particular, the maximum elongation was achieved when the intermediate heat treatment was performed at 120° C. and the final heat treatment was performed at 130° C. for 5 hours or 7 hours.

Although the invention made by the present inventors has been specifically described based on embodiments, the present invention is not intended to be limited to the above embodiments, and can be modified without departing from the gist thereof.

For example, the present invention can also be applied when a 6000 series aluminum alloy having composition other than that indicated in the embodiments is used. In addition, there is no problem even when the aluminum alloy wire of the present invention is used to produce a wire harness in which Mg₂Si is precipitated depending on the heat history in use.

It should be understood that the embodiments here disclosed are illustrative and are not limitative in every respect. The scope of the present invention is represented by not the above description, but the appended claims, and is intended to encompass all modifications within the meaning and scopes equivalent to the appended claims.

All the contents of the specification, the appended drawings, and the abstract encompassed in Japanese Patent Application No. 2015-131922 filed on Jun. 30, 2015 are herein incorporated.

1. An aluminum alloy wire formed by drawing an aluminum alloy comprising 0.40 to 0.55 mass % of Mg, 0.45 to 0.65 mass % of Si, and the balance including Al and unavoidable impurities, wherein
a Mg₂Si precipitate is not substantially present in an alloy after a final heat treatment.

2. An aluminum alloy wire according to claim 1, wherein
a wire diameter is 0.2 to 0.5 mm,
a tensile strength is 350 MPa or more,
an elongation is 6% or more, and
a conductivity is 50% IACS or more.
